(19) United States
(12) Patent Application Publication
(10) Pub. No.: US 2011/0189365 A1
(43) Pub. Date: Aug. 4, 2011

(54) Product and process for cryopreservation of marine aquarium foodstuffs

(76) Inventor: Dennis Tagrin, (US)

(21) Appl. No.: 12/931,565

(22) Filed: Feb. 3, 2011

Related U.S. Application Data
(60) Provisional application No. 61/337,393, filed on Feb. 3, 2010.

(51) Int. Cl. A23K 1/18; A23C 1/06

(52) U.S. Cl. 426/531; 426/442

(57) ABSTRACT

A method for preserving marine aquarium foodstuffs such as zooplankton crustaceans, gelatinous organisms, vertebrate and invertebrate larvae and eggs, shellfish, mollusks, fish and fish roe, oysters and clams, and sea urchins, wherein a supersaturated saline solution is prepared from reverse osmosis deionized water and marine salt, said solution is chilled to a low temperature, and said foodstuffs are immersed into said solution such that moisture is withdrawn from said foodstuffs via osmosis. The resulting product may then be stored and shipped at low temperatures for subsequent rehydration and use as a food product for a salt water aquarium ecosystem.

### STATEMENT TO CLAIM THE BENEFIT OF AN EARLIER-FILE PROVISIONAL APPLICATION

This Application is submitted pursuant to 35 USC §119(e), and claims the benefit of the earlier-filed provisional application serial number 61/337,393, filed on Feb. 3, 2010 by the same inventor.

### FIELD OF THE INVENTION

This invention relates generally to a method for preserving marine aquarium foodstuffs that utilizes a supersaturated saline solution in conjunction with cold temperature treatment and storage of the foodstuffs. This invention further relates to marine aquarium foodstuffs that are treated, preserved, and reconstituted via the method of the present invention. The method incorporates an initial pasteurization of the foodstuffs, which pasteurization provides for a denaturization of any digestive enzymes that would otherwise deplete the nutritive value of the foodstuffs prior to and during treatment and storage. This method further provides an anti-microbial treatment for those foodstuffs without utilizing an antimicrobial agent or other chemical additives that would alter or derogate from the nutritive value of the foodstuffs. This cryopreservation method is uniquely adapted for the preservation of zooplankton. Zooplankton are generally classified as pelagic marine organisms, a class of organisms which includes crustaceans, gelatinous organisms, vertebrate and invertebrate larvae and their eggs. In addition to preserving zooplankton, the process of the present invention may also be utilized to preserve eggs harvested from fish and shellfish, including mollusks, oysters and clams, crustaceans, sea urchins any other potential egg sources. This cryopreservation process can further be adapted for the preservation of whole or processed fish, mollusks, crustaceans, marine worms and algae. A primary benefit of this process is that it allows a marine aquarium food processor to efficiently and economically preserve foodstuffs in a manner that eliminates microbial contamination without chemical additives while simultaneously retaining the highest conceivable nutritional content of the preserved food.

### BACKGROUND AND SUMMARY OF THE INVENTION

Salt water aquariums are prevalent both in marine research facilities, public aquariums and among hobbyists around the world. A typical salt water aquarium may contain live corals and/or a variety of salt-water marine flora and fauna in a self-contained ecosystem.

One aspect of a marine ecosystem which presents unique challenges is the care and maintenance of live coral. There is no such thing as an all-inclusive coral food that will feed any species of coral. Particle size, texture and shape will determine whether a coral will feed on a particular food particle. There are also environmental conditions that affect the coral's ability to feed even if an edible food item is present. As a class, zooplankton, or pelagic marine organisms, which is a class of organisms that includes crustaceans, gelatinous organisms, vertebrate and invertebrate larvae and their eggs, encompasses a large variety of food items suitable for feeding live coral, many of which food items have a gelatinous structure. It is the mixture organisms found in zooplankton which provides the largest source of natural foods for corals.

Zooplankton are naturally prevalent in oceanic coral settings, but need to be introduced to feed coral in artificial aquariums maintained by science or research facilities, or by hobbyists. During transport to an artificial aquarium, however, a substantial majority of the living organisms that comprise zooplankton will become impaired and lose their nutritive value, as live zooplankton is not easily or readily stabilized or secured for transport.

Prior art methods for preserving zooplankton and other marine aquarium foodstuffs have relied primarily on dehydration and addition of preservatives. For example, Nichols in U.S. Pat. No. 4,537,785 describes a process to produce preserved fish foods that requires immersing live foodstuffs, including zooplankton, in an anhydrous liquid dessicant such as propylene glycol, followed by draining of the liquid from the dehydrated fish and addition of another quantity of anhydrous propylene glycol for preservative purposes. Nichols also teaches the addition of mold inhibitors and preservatives, such as calcium propionate, to better preserve the dehydrated foodstuffs during storage and transportation. While effective, this method substantially derogates from the nutritive value of the foodstuffs on multiple levels, including depletion of nutrients from the foodstuffs during the dehydration process and the introduction of artificial preservatives, which can subsequently alter the chemistry of a marine aquarium when the foodstuffs are utilized to feed the marine life in those aquariums.

More generally, persons skilled in the art of preserving living tissues have adapted other chemical preservative methods that enable biological materials to be stored for extended periods of time with minimal loss of biological activity. For example, Wiggins, et al. in U.S. Pat. No. 6,743,575B2 have taught that platelets can be preserved in solutions comprising betaine, sodium chloride and sodium citrate. A person skilled in the art of preserving marine foodstuffs may be able to adapt Wiggins' method to the preservation of zooplankton and other foods, but again, the addition of non-naturally occurring chemical substances into the preservation process poses the risk of contaminating the aquarium environment at a later time.

Other methods and processes that rely upon freezing or cold-temperature preservation and storage of marine aquarium foodstuffs will generally cause ice crystals to form within the cells of the zooplankton or other food sources that are being preserved. When these ice crystals form, cell walls will rupture and the integrity of the foodstuff is degraded. Flash freezing, which will cause many small water droplets to freeze within a cell, can sometimes be utilized to prevent this. Any slower freezing process, however, whether employed initially or subsequently after a flash-frozen product is thawed and is re-frozen, will cause the formation of single large water droplets that will rupture cell walls during the freezing process. When thawed, the ruptured cell walls will drain fluid, causing a loss of the nutritive value of the food.

Nichols, Wiggins and other persons skilled in the arts have therefore not solved the problem of preserving marine aquarium foodstuffs in a manner that maintains the highest possible nutritive value of those foodstuffs while simultaneously avoiding the use of artificial preservatives that may subsequently contaminate a marine aquarium environment.

Therefore, a need exists for a product and process that can safely and effectively preserve food sources for live corals, salt-water fish and other creatures that dwell in salt-water aquariums. The product and process described in this invention specification fulfills that need. This invention specifically defines a supersaturated saline solution that provides the basis for preservation of fresh or processed marine foodstuffs. Salt water marine aquariums are maintained as saline environments with a percentage salinity that approximates natural ocean saline conditions. By utilizing a supersaturated saline solution to preserve marine foodstuffs, this invention relies on a natural saline preservative that matches the chemical properties of a marine aquarium environment. Moreover, a supersaturated saline solution and the method of the present invention have both preservative and anti-bacterial properties. This method utilizes no unnatural chemicals or other artificial preservatives that might adversely affect the delicate chemical balance of a traditional salt-water aquarium. The method of the present invention further utilizes known and readily-available ingredients and equipment, and requires no extensive capital purchases or improvements by either the marine foodstuff manufacturer or the end user of the foodstuffs themselves.

Because of the ease of use and simplicity of the method and product comprising this invention, the marine foodstuff product associated with it may be readily utilized by both professional and amateur salt-water aquarium aficionados. Moreover, it is adaptable to any form of fresh or natural food source that is amenable to preservation methodologies. This invention further provides a quantum improvement over existing preservation methods in its use of a saline solution that blends with and thoroughly disperses in the natural saline environment of a salt-water aquarium.

### SUMMARY OF A PREFERRED EMBODIMENT OF THE DISCLOSURE

To improve upon the limitations of current methods for preserving marine aquarium foodstuffs, as described above, and to overcome other limitations that will become apparent upon reading and understanding the present specification, one embodiment of the method and product of the present invention calls for preparation of a supersaturated saline solution, which solution is then chilled to achieve a viscous consistency but which does not otherwise freeze or solidify. A quantity of zooplankton or other marine aquarium foodstuff is then immersed into this solution for a sufficient length of time to allow an osmosis process to draw moisture from the foodstuff until equilibrium is reached between the supersaturated saline solution and the liquid interior of the cells comprising the foodstuffs. The water drawn out of the foodstuffs being preserved lowers the salinity of the supersaturated saline solution. Therefore, repeated applications with fresh supersaturated saline solution may be required to achieve the desired effect. During this process, the supersaturated saline solution will be maintained at an appropriate temperature such that the foodstuffs being processed do not freeze, as freezing will prevent osmosis and result in damage to the cell structure of the foodstuffs.

The combination saline solution and foodstuff are then packaged together for low-temperature storage and transportation to the end user. Because the combined solution and foodstuff retains a soft or fluidic consistency, the end user can easily remove a smaller quantity of the combined saline solution and foodstuff from the total quantity that was stored and transported to the end user. The end user can then introduce that quantity into a marine aquarium, in which environment the foodstuff will rehydrate. Excess salinity in the quantity that is introduced to the aquarium will disperse into the natural saline environment of the aquarium, and the resulting foodstuff will provide a high-nutritive food source to the marine aquarium life that is present in the aquarium. Where the foodstuff that is utilized in this process comprises zooplankton or other sources that may include digestive enzymes, it is preferable to pasteurize the zooplankton prior to preserving it via this process in order to denature the digestive enzymes. This pasteurization and denaturing process prevents any naturally-occurring digestive enzymes from degrading the nutritive value of the foodstuff during storage and transportation.

### DETAILED DESCRIPTION OF THE INVENTION

The method of the present invention begins with a supersaturated saline solution that is the basis of the cryopreservation of marine aquarium foodstuffs. This solution is comprised of reverse osmosis deionized (“RODI”) water and standard, readily-available marine aquarium salt or salt suitable for use in a marine aquarium. A solution of these two products is made, the final salinity of which is sufficient to prevent the solution from freezing when placed in a severely refrigerated e. at least −20° C./−4° F.) environment. An ideal salinity and temperature for the method of the present invention is between 28.5% and 28.9% salt at −15° F. The ideal salinities and temperatures can be adjusted for preservation methods for a shorter shelf life for refrigerated, non-frozen storage (i.e. 4° C. /39° F.). Persons skilled in the art will be well-versed in determining the exact salinity of the solution that is required to achieve this non-freezing characteristic. In practice, when placed in this severely refrigerated environment, the solution (depending on temperature) will be more viscous than water, but it will continue to flow smoothly when poured from a container at this low temperature.

This supersaturated saline, chilled solution comprises the foundation for preserving fresh marine foodstuffs. When marine aquarium foodstuffs are immersed into this chilled, supersaturated saline environment, natural moisture will be drawn from the foodstuffs and into the saline solution through osmosis. The osmosis process is accomplished with minimal or no rupture of the cell walls of the foodstuffs, which allows the foodstuffs to retain a relatively high nutritive value. Further, the foodstuffs that proceed through this initial step will no longer susceptible to bacterial contamination, as bacteria are unable to grow or thrive in the supersaturated saline solution due to their desiccation by osmosis. Because the process of osmosis has removed most of the water molecules from the cells, damaging ice crystals will not form within the cells of the foodstuffs.

As the foodstuffs and supersaturated saline solution come into equilibrium, the water which is drawn out of the cells of the foodstuffs will dilute and reduce the total salinity of the solution. Thus, additional saline may need to be added to the solution to maintain the desired salinity level of 28.5% and 28.9% salt at −15° F. The addition of extra saline may need to be repeated one or more times in order to draw the maximum desired amount of water from the cells of the foodstuffs. A person skilled in the art will have multiple tools available to him or her in order to determine the number of times to repeat this step of additional saline.

This process draws a substantial amount of water out of the foodstuffs, which prevents large, damaging ice crystals from forming at a microscopic level within the cellular wall structures of the foodstuffs. This preserves the overall cellular structure and integrity of the foodstuffs. Prior attempts to freeze fresh marine foodstuffs have failed at this level because of formation of large, damaging ice crystals in cell walls. Once the walls are ruptured by these crystals, the foodstuffs lose a substantial portion of their base nutrient value because, upon rehydration, the nutrients will drain from the cell structures through ruptured cell walls.

The manufacturer or marine food processor that utilizes this method will first ideally establish an ionic balance formula containing both the chilled, supersaturated saline solution and the marine foodstuffs that the manufacturer or marine food processor seeks to preserve. The manufacturer of marine food processor will then package this product into appropriate cold-storage containers for cold-temperature warehousing and ultimate shipment, via refrigerated shipping, to the end user. The end user can then use this product in a marine aquarium salt-water environment by simply drawing the desired amount of product out of the storage and shipping container, and storing the remainder under refrigerated conditions. Because the product never freezes or solidifies, drawing and removing a lesser portion of the product is easily accomplished.

The lesser portion that is removed will ideally be placed into a container of marine aquarium water and will be allowed to equilibrate to a higher temperature and will rehydrate through osmosis. The end user can then infuse the rehydrated and thawed product into his salt-water aquarium ecosystem with no fear or concern of adding anything unnatural, and particularly no chemical additives or preservatives that might otherwise harm the marine environment.

The addition of salt or excess saline solution into the marine aquarium environment is not significant, as it part of normal marine aquarium maintenance. To the extent that any excess salinity is too large a quantity for a particular aquarium environment, the owner or other person who maintains that environment can simply add water to dilute the salinity to a more appropriate level. A typical owner or other person who maintains a salt-water aquarium will generally have the skill and experience necessary to achieve the ionic balance and salinity that will not adversely affect or change the salinity of his or her aquarium.

The manufacturer can enhance the desirability of this process and product, for example, by adding fatty acids, amino acids, vitamins, or other beneficial additives to the combined preserved solution prior to shipping that solution to the end user. Nutritional additives such as vitamins, omega3 fatty acids and amino acids can be added to the food product. Liquid additives will be absorbed into the tissue of fish or mollusks when placed into aquarium water with the resulting enhancement of the nutritional value. These additives are similarly unaffected by the hyper-salinity of the solution and their nutritive value remains and is maintained by the preservative product and process throughout the shipping and storage process.

This product and process may be used with any traditional or non-traditional foodstuffs that are used to feed salt-water aquariums, including, by way of example only and not by way of limitation, plant-based and other marine algaes, whole or processed crustaceans, shellfish, mollusks, whole or processed fish, fish roe, and the roe of other marine organisms. Normal aquarium maintenance of the salinity of the aquarium would ultimately adjust itself naturally with no adverse effect upon the animal and plant life in that aquarium. This is so because the individual components that comprise the solution are identical to the components that are already in the aquarium.

Where the foodstuffs that are treated and preserved via the method of the present invention have naturally-occurring digestive enzymes, an additional pre-treatment step of pasteurization will be desirable to denature those enzymes prior to preservation. If the enzymes are not denatured via pasteurization, they may cause a breakdown of the integrity of the foodstuffs, which will essentially begin to digest themselves via a process that is catalyzed by these enzymes. If the enzymes are not so denatured, the nutritive value of the foodstuffs will be lost during storage and transportation. Although pasteurization is the preferred additional step for denaturing these enzymes, persons skilled in the art will realize that other denaturing processes are available, and that those other processes may be more desirable, depending on the particular foodstuff that is being treated.

The foregoing embodiment of the present invention describes the method and product of the invention specifically in the context of salt-water marine aquariums. It can be readily seen, however, that this invention may be readily adapted, for example, for use with preservation of any types of foodstuffs that are amenable to preservation via the use of a supersaturated saline solution and/or freezing, including, for example, a variety of protein, carbohydrate, and vegetable food sources. Food scientists and other persons skilled in the art will readily adapt the products and process of this invention to multiple uses and purposes.

This concludes the description of the preferred embodiment of the present invention. This description has been presented for purposes of illustration and description. It is not intended to be exhaustive or to limit the invention to the precise method disclosed. Many modifications and variations are possible in light of the above teaching. It is not intended that the scope of the invention will be limited by the foregoing description.

What I claim is as follows:

1. A process and method for producing a preserved fish and invertebrate food from marine aquarium foodstuffs comprising:
Preparing a supersaturated saline solution, said solution comprising reverse-osmosis deionized water and marine aquarium salt;
Chilling said supersaturated solution in a refrigerated environment such that said supersaturated solution achieves a consistency that is more viscous than water but does not otherwise solidify or freeze, retaining fluidic characteristics;
Immersing a quantity of fresh marine aquarium foodstuffs into said chilled, supersaturated solution for a sufficient amount of time to draw moisture from the marine aquarium foodstuffs; and
Packaging the resulting combination of chilled supersaturated solution and moisture-depleted marine aquarium foodstuffs in containers suitable for storing and shipping the same in a low-temperature environment.

2. The process and method for producing a preserved fish and invertebrate food as in claim 1, wherein the marine aquarium foodstuffs comprise zooplankton and pelagic marine organisms, namely, crustaceans, gelatinous organisms, vertebrate and invertebrate larvae and eggs, shellfish, mollusks, fish and fish roe, and the roe of other marine organisms.

3. The process and method for producing a preserved fish and invertebrate food as in claim 1, including the further step of rehydrating the combination of chilled supersaturated solution and moisture-depleted marine aquarium foodstuffs, via the process of removing a quantity of the same from a storage container, and placing said quantity into a container of marine aquarium water for a sufficient amount of time to allow full thawing and rehydration of said quantity.

4. The process and method for producing a preserved fish and invertebrate food as in claim 1, including the further step of adding one or more nutritive supplements and vitamins to said combination of chilled hyper-saline solution and moisture-depleted marine aquarium foodstuffs prior to packaging.

5. The process and method for producing a preserved fish and invertebrate food as in claim 1, including the further step of treating the marine aquarium foodstuffs via pasteurization prior to immersing them into a chilled, supersaturated saline solution.

6. The process and method for producing a preserved fish and invertebrate food as in claim 1, including the further step of adding one or more quantities of additional saline to the combined chilled supersaturated solution and moisture-depleted marine aquarium foodstuffs prior to packaging, wherein the additional saline is added to maintain a saline concentration of 28.5% and 28.9% salt at −15° F.

7. A preserved fish food produced by the process described in claim 1.

8. The process and method for producing a preserved fish and invertebrate food as in claim 1, wherein the chilled, supersaturated saline solution is chilled to temperatures equal to or lower than 39° F./4° C.

9. The process and method for producing a preserved fish and invertebrate food as in claim 1, wherein the combined solution and quantity of zooplankton is stored and shipped at temperatures equal to or lower than 39° F./4° C.

10. The process and method for producing a preserved fish and invertebrate food as in claim 1, wherein the supersaturated saline solution has an initial salinity of between 28.5% and 28.9% at −15° F.
